(19) United States
(12) Patent Application Publication
(10) Pub. No.: US 2007/0154683 A1
(43) Pub. Date: Jul. 5, 2007

(54) Microstriped film

(75) Inventors: Ronald W. Ausen, St. Paul, MN (US); Jayshree Seth, Woodbury, MN (US); Janet A. Venne, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/321,413

(22) Filed: Dec. 29, 2005

(51) Int. Cl. B32B 3/00

(52) U.S. Cl. 428/172

(57) ABSTRACT

There is provided a coextruded film or film layer comprises at least two sets of regions, a first set of regions formed predominately of a first thermoplastic polymer and a second set of regions formed predominately of a second thermoplastic polymer arranged in an alternating side-by-side manner. These side-by-side polymer regions generally extend in a machine direction in a continuous manner. The film or film layer has a first face and a second face. On at least one face, one of the regions of the first thermoplastic polymer bridges over the adjacent lane of another (the second thermoplastic polymer region or a third thermoplastic polymer region) thermoplastic polymer region creating on the first face a continuous layer of the first thermoplastic polymer. The opposite face comprises at least in part the other thermoplastic polymer. This bridging layer of the first thermoplastic polymer maintains the integrity of the film or film layer in the cross direction to the machine direction without the need for compatibilizers or tie layers, and allows for the other thermoplastic polymer regions to be exposed on the second face.

### BACKGROUND OF THE INVENTION

The present invention relates to a film having relatively closely spaced side-by-side zones of different thermoplastic polymers.

There are a considerable number of patents which describe films that have side-by-side zones of thermoplastic materials. These films are generally described as formed by coextrusion of the polymers. There are no problems with this method if the polymers used are closely compatible, such that they form a strong bond at the polymer interfaces. However problems occur with coextrusion in that many different combinations of thermoplastic polymers are not compatible or have little or no mutual adhesion properties. If these combinations of thermoplastic polymers are coextruded in a side-by-side configuration they can often easily separate at the polymer interface making the film very weak in the cross direction (the direction that is transverse to the extrusion direction). U.S. Pat. Nos. 6,211,483 and 6,669,887 describe thermoplastic elastomers coextruded in a side-by-side manner with thermoplastic nonelastic polymers. To increase bond strength between these two different types of polymers, specific polymer pairs are selected which have improved mutual adhesion properties. Specifically, tetrablock SEPSEP was described as exhibiting improved bond strength to polyolefins when blended with end block reinforcing resins. Compatibilizers are also preferably used.

Side-by-side coextrusion is also described in U.S. Patent Publication No. 2005/0060849 A1. In this case, the problem of joint strength is not addressed directly but it is recognized as a problem that needs to be considered. The problem is addressed solely by stating that if compatibility is a problem then compatibility agents should be added to the polymeric materials or a tie layer should be used, or the side-by-side regions of incompatible polymers should be extruded onto a carrier substrate. In the latter case the carrier substrate provides the strength to keep the side-by-side layers from separating at their mutual interfaces.

U.S. Pat. Nos. 5,620,780; 5,773,374 and 5,429,856 describe a coextruded material where a core of elastic material is completely surrounded by an inelastic material. This can create zones having elastic and inelastic properties even if there is a compatibility problem as separation is prevented by the continuous phase of inelastic material with the elastic being in the form of islands or continuous stripes or strands.

It would be desirable to provide a film having side-by-side regions of thermoplastic polymers, which could be directly formed without the need for chemical modifiers, additional tie layers or supports. Specifically it would be desirable to form a film having continuous side-by-side regions of elastic and inelastic materials which can be directly formed in an extrusion die and has cross directional elasticity with little or no delamination at the polymer interfaces.

### SUMMARY OF THE INVENTION

The invention coextruded film or film layer comprises at least two sets of regions, a first set of regions formed predominately of a first thermoplastic polymer and a second set of regions formed predominately of a second thermoplastic polymer arranged in an alternating side-by-side manner. These side-by-side polymer regions generally extend in a machine direction in a continuous manner. The film or film layer has a first face and a second face. On at least one face, one of the regions of the first thermoplastic polymer bridges over the adjacent lane of another (the second thermoplastic polymer region or a third thermoplastic polymer region) thermoplastic polymer region creating on the first face a continuous layer of the first thermoplastic polymer. The opposite face comprises at least in part the other thermoplastic polymer. This bridging layer of the first thermoplastic polymer maintains the integrity of the film or film layer in the cross direction to the machine direction without the need for compatibilizers or tie layers, and allows for the other thermoplastic polymer regions to be exposed on the second face.

### BRIEF DESCRIPTION OF THE DRAWINGS

FIG. 1 is a schematic view of an extrusion apparatus used for the invention material.

FIG. 1a is a schematic view of an extrusion die with a die insert used in the extrusion apparatus of FIG. 1.

FIG. 2 is a perspective view of a die insert used in the present invention viewed from the insert outlet.

FIG. 3 is a perspective view of a die insert used in the present invention viewed from the die insert inlet.

FIG. 4 is a cross-sectional view of a side-by-side two layer coextruded film in accordance with the invention.

FIG. 5 is a cross-sectional view of a side-by-side coextruded film of FIG. 4, in accordance with the invention, with an attached nonwoven layer.

FIG. 6 is a cross-sectional view of a side-by-side three layer coextruded film in accordance with another embodiment of the invention.

### DESCRIPTION OF THE INVENTION

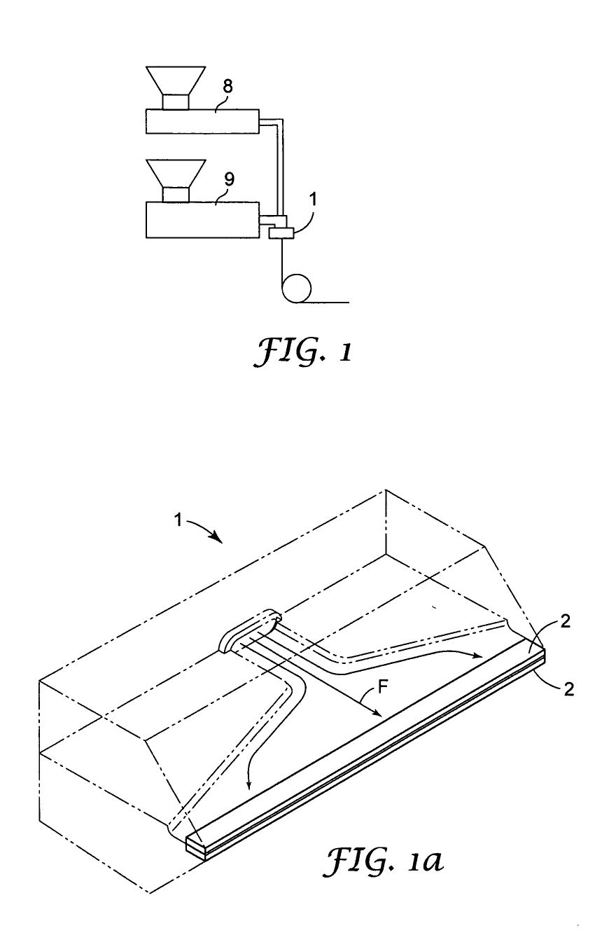

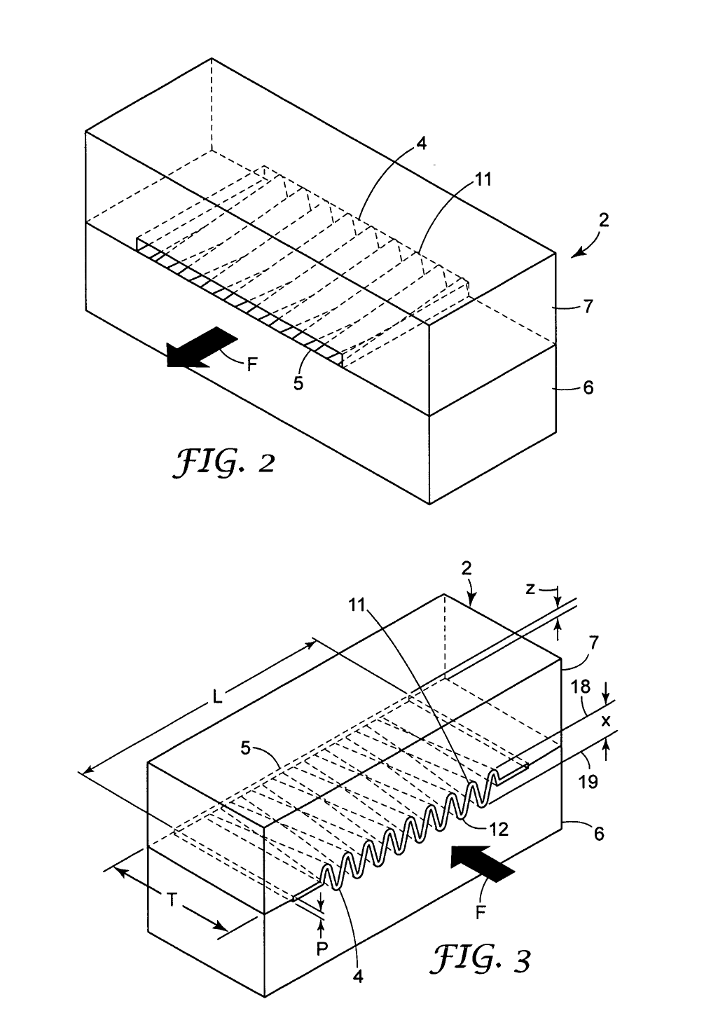

An extrusion apparatus used in a method for forming the coextruded film (the term “film” as used herein can also refer to film layer in a multilayer film) of the invention is schematically illustrated in FIG. 1. The die 1 used in the FIG. 1 extrusion apparatus is shown in FIG. 1a. Generally, the method used to form the invention film includes first extruding an initial multilayer melt stream along a predetermined flowpath F through a die insert 2, such as the die inserts 2 shown in FIGS. 2 and 3. The predetermined flowpath F is preferably one dimensional and continuous along some portion of the flowpath. By one dimensional it is meant that the melt stream could be any one dimensional linear type shape such as a straight line, but it could be a curved line, which curve could intersect itself and form an oval or round form (e.g. an annular die).

As shown in FIG. 1, the melt stream is delivered from conventional extruders 8 and 9 through the die 1 having at least one die insert 2, where the die insert has a profiled non-rectilinear inlet opening 4 with the flowpath oscillating regularly or irregularly between a series of peaks 11 and 12, on either side of a centerline of the flowpath. By non-rectilinear it is meant that the die insert inlet opening 4 as a whole is in a form other than a rectangular shape, however portions of the die inlet openings could be rectilinear in form. The die insert inlet opening 4 interrupts at least portions of the incoming initial melt stream and redirects portions of the interrupted melt stream from the predetermined initial melt stream flowpath form to a flowpath (or flowpaths) form defined by the die insert inlet opening 4. The interrupted and redirected melt stream is then converged in the die insert 2 to a generally converging flowpath, defined by the die insert from the profiled shape at the die insert inlet opening 4 to the die insert outlet 5. The converged melt stream flowpath at the die insert outlet 5 can be similar in shape to the original predetermined melt stream flowpath (e.g. rectangular or one dimensional). The die insert 2 used for this method causes a redistribution of the initial melt flow stream, at least in part in the cross direction, creating a side-by-side redistribution of one or more layers of the incoming multilayer polymer melt stream. The melt stream at the die insert outlet is then extruded as an article, such as a film or the like. By melt stream it is meant a stream of a Newtonian or viscoelastic fluid capable of being extruded and solidified at the exit of a die. The material may or may not be in a melt phase.

The insert shown in the embodiment discussed above is a separate element located within the die. The insert could also be formed integral with the die and/or feedblock in which it is located as long as it has the features described. The term insert is used to identify any structure providing a profiled inlet and other features as described, regardless if in a die, feedblock or another component.

A multilayer melt stream can be formed by any conventional method. The coextruded multilayer melt stream generally has a structured arrangement, such as a conventional layered multilayered flow stream of substantially constant thickness layers, however the layer thicknesses could vary regularly or randomly, either by design of the die and or feedblock and/or due to rheological differences of the polymers. Known multilayer extrusion processes include those disclosed in U.S. Pat. Nos. 5,501,675; 5,462,708; 5,354,597 and 5,344,691, the substance of which are substantially incorporated herein by reference. These references teach various forms of multilayer elastomeric laminates, with at least one elastic layer and either one or two relatively inelastic layers. A multilayer film, however, could also be formed of two or more elastic layers or two or more inelastic layers, or any combination thereof, utilizing these known multilayer coextrusion techniques.

The melt stream is redirected or redistributed at the insert inlet and within the insert by the insert profile converging from its initial nonlinear or non-rectilinear flowpath form (cross-sectional shape of the flowpath or die cavity at a given point) to a substantially more linear or rectilinear flowpath form and/or a flowpath form that can resemble the initial predetermined material(s) flowpath form. The polymer(s) forming one or more layers of the precursor melt stream are redistributed or redirected at least in the cross direction relative to the initial predetermined material flowpaths or forms. The redirected flow is caused at least in part by disruption or interruption of a portion of the melt stream flow at the insert inlet. The disrupted melt stream converges along a flowpath within the insert into a less structured form, which can be similar to the original melt stream flowpath form, e.g. a rectangular insert opening or the like, where at least a part of one layer or portions of the initial melt stream has been partitioned into different proportions in different zones or regions, such as in the width or cross direction of the extruded material or film emerging from the die insert outlet opening. Where an insert is positioned closer to the feedblock, or in the feedblock, the polymer melt stream flowpath form will be less elongated into a film-like structure and will have a higher ratio of height to width. This will result in relatively larger zones of the polymer melt being redistributed by the insert. Where the insert is closer to the die outlet the incoming polymer melt stream flowpath form will be more elongated into a film-like form having a smaller ratio of height to width. An insert at this point would redistribute smaller portions of the incoming polymer melt flow stream. These two types of inserts can be combined to permit both large scale and smaller scale polymer redistribution on the same melt stream.

The insert 2 can be easily fitted into a conventional die (such as a coat hanger die) as shown in FIG. 1a. Generally an insert 2 can be readily removed, replaced and cleaned if the die insert is formed of multiple disassemblable components, such as first and second halves 6 and 7 as shown in FIGS. 2 and 3. This die insert can be easily taken apart and cleaned for maintenance and reassembled. Using multiple die components to form a die insert also allows for more complex flow channels to be formed by conventional methods such as electron discharge wire machining. Although a two-piece die insert is shown, multiple-piece die inserts are also possible allowing for more complex flow channels or flowpaths to be formed in the assembled die insert. The die insert could also be formed in whole or in part with other parts of the die. The flowpaths within the die insert however are preferably substantially continuous and converging, such that they, in at least part of the flowpath within the die, taper in a linear fashion.

The insert inlet opening (or portions thereof) can also be characterized by the ratio of the perimeter of a section of the insert inlet opening to an equivalent rectangular die insert opening (an opening having the same length L and same average width dimension P). The ratio of the perimeter of the invention insert inlet opening to the perimeter of an equivalent rectangular insert inlet opening is the perimeter ratio, which can be between 1.1 and 10 or greater than 1.1 or 1.5 or 2.3, but generally less than 8 or 5. Structures with larger perimeters or perimeter ratios are considered more highly structured openings. With more highly structured openings there is generally a more dramatic redistribution of the melt flow from the incoming initial melt flow stream, such as a multilayer or multicomponent flow stream. This is generally due to more possible alternative flowpaths for a given interrupted flowpath. However, with a very large perimeter ratio with a relatively low level of closed areas (e.g. the areas in region x without a die opening) very little of the melt is significantly redistributed. More closed areas (lower percent open area) leads to more dramatic redistribution of at least some portion of the incoming melt flow stream, particularly when coupled with more highly structured continuous openings or discontinuous openings.

Generally some thermoplastic material of one or both layers, at given points in the melt flow stream, is forced to find alternative flow paths. With a highly structured opening there are a larger variety of unique possible flow paths in the region bounded by the two peaks 11 and 12. The thermoplastic material is more easily diverted when there are a large number of possible flow paths that deviate from a mean flow path. For a given insert opening this is defined as the flow path deviation factor as defined in copending application Ser. No. 11/02618, filed Dec. 30, 2004, the entirety of which is incorporated by reference. Generally this deviation factor is greater than 0.2, or greater than 0.5, up to 2 or 3, however higher deviation factors are possible. With a higher deviation factor there are more possible flow paths that are spaced apart in between the top boundary 18 and the bottom boundary 19. The outlet of the die insert can also have a deviation factor but preferably much less than the corresponding inlet. Generally the outlet has a deviation factor at least 50 percent less, or 80 percent less than the inlet. The outlet can have a deviation factor of zero to provide the greatest amount of flow redistribution and create a flat profiled film or melt stream.

Generally, the insert from the inlet opening tapers substantially continuously to the insert outlet opening. Alternative tapering channels within the insert are also possible, such as channels that taper outwardly for some portions of its flowpath or tapers in step function changes between the die insert inlet and outlet openings.

The open area of the insert inlet opening is generally greater than the open area of the insert outlet opening where the ratio of the inlet to outlet opening is from 0.9 to 10 or 1 to 5. Although it is possible for the inlet area to be less than that of the outlet this would create more back pressure and thicker film structures.

As previously stated the melt stream layers generally will follow the shortest flowpath to an inlet opening (determined by the outlet width z), which for an uppermost melt stream layer would generally be the peaks 11 and for a lowermost melt stream layer would be the peaks 12. Generally, with any given portion of the polymer melt stream flow; the material will tend to flow to the closest opening provided by the inlet 4.

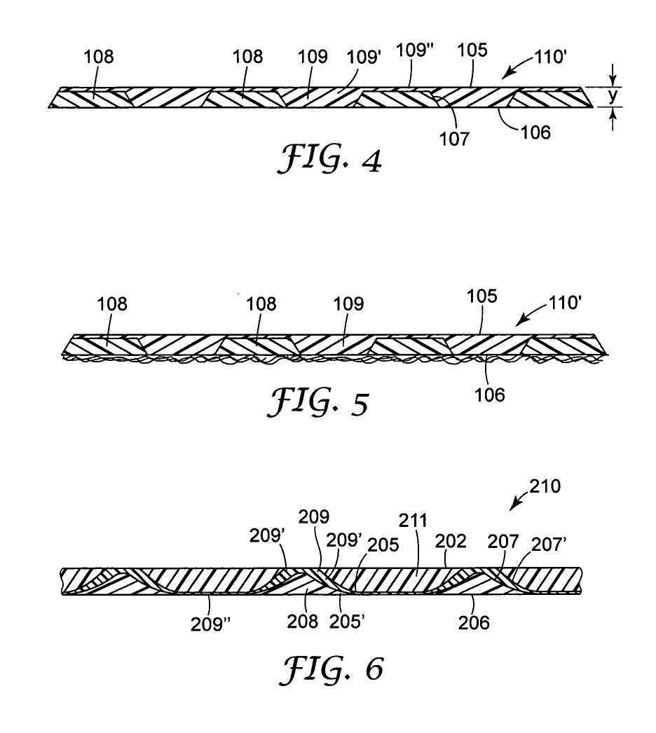

FIG. 4 shows a side-by-side film formed by the invention method. The uppermost melt stream layer (not shown) forms a film layer 109 which is redistributed in the peaks 11 of the die opening to form a set of regions 109′. The lower polymer melt stream layer (not shown) redistributes to form a set of regions 108. The regions 108 and 109′ are in a side-by-side arrangement with a thin bridging film layer 109″ of the film layer 109 polymer material bridging adjacent regions 109′. This bridging film layer 109″ between regions 109′ maintains the structural integrity of the side-by-side regions 108 and 109′ even if they are not otherwise well bonded at the side-by-side interface 107. This is true even if the bridging film 109″ is as thin as 0.25 microns. The bridging film 109″ and the film region 109′ are continuous and form a continuous face 105 of the film layer 109. The opposite face 106 is formed of both film layer 109 and polymer regions 108. Ideally the thickness of the bridging film layer 109″ will be from 0.25 to 50 microns or 1.0 to 10 microns, and the overall film thickness can be from 15 microns to 500 microns or 50 to 250 microns. The first and second regions generally can be 0.1 to 10 mm wide or 1.0 to 5 mm wide.

The bridging film layer 109″ is created in the flow redistribution process. One or the other, or both, of the outermost melt stream layers forming the side-by-side regions will not entirely redistribute to the closest flow path on one side of the die insert (such as the closest peak 11 or 12 in FIGS. 2 and 3) and instead redistribute to an opposing side of the die insert (such as the opposing peak 11 or 12 in FIGS. 2 and 3). This is believed to be due to the melt strength of the thermoplastic material. This generally is a very thin bridging film and in and of itself would not have much strength. However, this thin bridging region unexpectedly provides significant strength to the side-by-side film structure as a whole, in the cross direction.

Generally the melt layers are partitioned along the width-wise extension of the extrudate such that the proportion of the two (or more) melt stream layers varies across the extrudate width. In a two-layer embodiment of the invention, this variation is such that there is a substantially complete partitioning of the materials with at least one of the film layers forming a thin bridging film between adjacent regions. With three or more melt stream layers at least one of the film layers, generally will vary in thickness across the transverse direction of the extrudate and form a bridging film layer. A film layer varying in thickness will generally comprise 0-90% of the total extrudate thickness. Any of the film layers can comprise from 0-100% of the total thickness of the extrudate at any point across the width (X-direction) of the extrudate. The film layer varying in thickness will generally vary by at least 10 percent comparing the thickest region to the thinnest region or alternatively, by at least 20 percent or at least 50 percent. The partitioning will be dictated by the relative proportions of the precursor melt stream layers and the shape of the opening of the insert 4. With an insert having a regularly oscillating opening as shown in FIGS. 2 and 3, the partitioning can result in a film as shown in FIGS. 4 or 5 (assuming a coextruded multilayer melt stream with relatively constant equal layer thicknesses of the materials across the melt stream). FIG. 5 is the FIG. 4 film extrusion or otherwise laminated to a nonwoven layer. The advantage of the invention film is that the nonwoven or other layers can be bonded to a face 106, which has two different exposed polymer regions with different bonding characteristics. For example the regions could be such that one region could be more highly bonded to a nonwovens or the like than an adjacent region creating, for example, lofty zones and less lofty zones or extensible zones and less extensible zones.

FIG. 6 shows a side-by-side film of the invention as part of a larger multilayer film 210. A middle layer of a three layer melt stream (not shown) redistributes to the peaks 12 to form a set of regions 209′. A lowermost polymer melt stream layer (not shown) also redistributes to the peaks 12 to form a set of regions 208. An uppermost polymer melt stream layer (not shown) redistributes to the peaks 11 forming a third set of regions 211. The regions 208, 209′ and 211 are in a side-by-side arrangement with a thin bridging layer 209″ of the film layer 209 polymer material bridging adjacent regions 211. This bridging film layer 209″ between regions 211 maintains the structural integrity of the side-by-side interfaces 207 and 207′. The film layer 209 forms two continuous film faces 205 and 205′ relative to the two sets of regions 208 and 211, respectively. The film face 206 opposite face 205 is formed of the film layer 209 and regions 208. The film face 202 opposite 205′ is formed of film layer 209 and regions 211. Unlike in the two layer embodiment of FIG. 4, the thin bridging layer 209″ does not bridge over the regions 208 which it is keeping integral, rather it bridges over a second set of regions 211, which in combination with the bridging layer 209″ keeps the regions 208 from separating from regions 209′. Regions 211 are kept together by regions 209′ and bridging regions 209″.

Suitable polymeric materials from which the coextruded films of the invention can be made include thermoplastic resins comprising polyolefins, e.g., polypropylene and polyethylene, polyvinyl chloride, polystyrene, nylons, polyester such as polyethylene terephthalate and the like and copolymers and blends thereof. Preferably the resin is a polypropylene, polyethylene, polypropylene-polyethylene copolymer or blends thereof. Inelastic layers are preferably formed of semicrystalline or amorphous polymers or blends. Inelastic layers can be polyolefinic, formed predominately of polymers such as polyethylene, polypropylene, polybutylene, or polyethylene-polypropylene copolymer.

Elastomeric polymeric materials which can be used in the coextruded films of the invention include ABA block copolymers, polyurethanes, polyolefin elastomers, polyurethane elastomers, metallocene polyolefin elastomers, polyamide elastomers, ethylene vinyl acetate elastomers, polyester elastomers, or the like. An ABA block copolymer elastomer generally is one where the A blocks are polyvinyl arene, preferably polystyrene, and the B blocks are conjugated dienes specifically lower alkylene diene. The A block is generally formed predominately of monoalkylene arenes, preferably styrenic moieties and most preferably styrene, having a block molecular weight distribution between 4,000 and 50,000. The B block(s) is generally formed predominately of conjugated dienes, and has an average molecular weight of from between about 5,000 to 500,000, which B block(s) monomers can be further hydrogenated or functionalized. The A and B blocks are conventionally configured in linear, radial or star configuration, among others, where the block copolymer contains at least one A block and one B block, but preferably contains multiple A and/or B blocks, which blocks may be the same or different. A typical block copolymer of this type is a linear ABA block copolymer where the A blocks may be the same or different, or multi-block (block copolymers having more than three blocks) copolymers having predominately A terminal blocks. These multi-block copolymers can also contain a certain proportion of AB diblock copolymer. AB diblock copolymer tends to form a more tacky elastomeric film layer. Other elastomers can be blended with a block copolymer elastomer(s) provided that they do not adversely affect the elastomeric properties of the elastic film material. A blocks can also be formed from alphamethyl styrene, t-butyl styrene and other predominately alkylated styrenes, as well as mixtures and copolymers thereof. The B block can generally be formed from isoprene, 1,3-butadiene or ethylene-butylene monomers, however, preferably is isoprene or 1,3-butadiene.

In preferred embodiments at least one layer is elastic with at least one inelastic layer, forming a film or film layer with side-by-side sets of elastic and inelastic regions. At least one of the elastic or inelastic regions will form a bridging layer. This would provide, as shown in FIGS. 4 and 5, a film with multiple side-by-side elastic or inelastic regions, at least one face 105 formed entirely of one of the inelastic or elastic materials and the opposite face 106 formed in whole or in part of the other material. This allows the film to have different bonding and friction coefficients on opposing faces while creating a machine and cross directional stable side-by-side elastic film. This side-by-side film embodiment of the invention maximizes the elastic material's performance while providing a film that has the superior bonding characteristics of an inelastic material on at least one face. It also provides a film that is readily elastic in the cross direction and inelastic in the machine direction, allowing it to be used in high speed manufacturing processes and equipment, which requires films that are dimensionally stable in the machine direction. However the film could be stretch activated in the machine direction in manners know in the art to create a machine direction elastic film.

With all the embodiments, the side-by-side layers could be used to provide specific functional or aesthetic properties in one or both directions of the film such as elasticity, softness, hardness, stiffness, bendability, roughness, colors, textures, patterns or the like.

The invention film could be used in any known extrusion or film process or product. For example the invention film could be embossed, laminated, oriented, cast against a microreplicated surface, foamed, extrusion laminated or otherwise manipulated or treated as is known with extrusion formed film or film layers.

### EXAMPLES

### Example 1

A coextruded web was made using apparatus similar to that shown in FIG. 1. Two extruders were used to produce a two layer extrudate consisting of a first ‘A’ polypropylene layer and a second ‘B’ elastic layer. The first layer was produced with a polypropylene homopolymer (99% 3762, 12 MFI, Atofina Inc., Houston, Tex.) and 1% red polypropylene-based color concentrate. The second elastic layer was produced with a blend of 70% KRATON G1657 SEBS block copolymer (Kraton Polymers Inc., Houston, Tex.) and 30% Engage 8200 ultra low density polyethylene—ULDPE (Dow Chemical Co., Midland, Mich.). A 3.81 cm single screw extruder (70 RPM) was used to supply 3762 polypropylene for the first layer and a 6.35 cm single screw extruder (10 RPM) was used to supply the KRATON/ULDPE blend for the second layer. The barrel temperature profiles of both extruders were approximately the same from a feed zone of 215° C. gradually increasing to 238° C. at the end of the barrels. The A and B melt streams of the two extruders were fed to an ABC three layer coextrusion feedblock (Cloeren Co., Orange, Tex.). The C layer port was not used. The feedblock was mounted onto a 20 cm die equipped with a profiled die lip similar to that shown in FIGS. 2-3. The feedblock and die were maintained at 238° C. The die lip was machined such that the angle between two successive channel segments was 25 degrees. The wavelength of the pattern is 1.25 mm. The amplitude of the pattern is 2.59 mm at a die gap setting of 0.5 mm. The die lip thickness T is 6.25 mm. The pattern transitions from a profile to flat over this thickness T. After being shaped by the die lip, the extrudate was quenched and drawn through a water tank at a speed of 10 meter/min with the water being maintained at approximately 45° C. The web was air dried and collected into a roll. The resulting web as depicted in FIG. 4 had a side-by-side-type structure as a result of the partitioning of the two melt streams across the extrudate width. The elastic layer 109 formed a bridging film 109″ between adjacent elastic regions. The basis weight of the extruded film was 114 grams/meter².

1. A coextruded film comprising at least two sets of regions, a first set of regions formed predominately of a first thermoplastic polymer and at least a second set of regions formed predominately of a second thermoplastic polymer arranged in an alternating side-by-side manner, the two sets of regions of said film having a first face and a second face, at least two adjacent regions of the first thermoplastic polymer are separated by a side-by-side region of another thermoplastic polymer region such that these at least two adjacent regions of the first thermoplastic polymer, in the other thermoplastic polymer region is in the form of a thin bridging layer that bridges over the other thermoplastic polymer region creating on the first face a continuous layer of the first thermoplastic polymer, where the opposite second face comprises at least in part the other thermoplastic polymer.

2. The coextruded film of claim 1 wherein the film is comprised of two regions and the other thermoplastic polymer region is the second thermoplastic region.

3. The coextruded film of claim 1 wherein the film is a three or more layer film where the other thermoplastic polymer regions are a third set of regions.

4. The coextruded film of claim 3 where the first polymer bridges over the second polymer regions forming the thin bridging layer.

5. The coextruded film of claim 1 wherein the first thermoplastic polymer is a thermoplastic elastomer.

6. The coextruded film of claim 5 wherein the other thermoplastic polymer is inelastic and the second thermoplastic polymer is an elastomer.

7. The coextruded film of claim 2 wherein the first thermoplastic polymer is inelastic and the second thermoplastic polymer is an elastomer.

8. The coextruded film of claim 2 wherein the first and second regions are substantially continuous along the length of the film.

9. The coextruded film of claim 2 wherein the first and second regions are from 0.1 to 10 mm wide.

10. The coextruded film of claim 8 wherein the first and second regions are from 1.0 to 5 mm wide.

11. The coextruded film of claim 8 wherein the bridging layer thickness is from 0.5 to 50 microns.

12. The coextruded film of claim 8 wherein the bridging layer thickness is from 1.0 to 10 microns

13. The coextruded film of claim 2 wherein the overall film thickness is from 15 to 500 microns

14. The coextruded film of claim 13 wherein the overall film thickness is from 50 to 250 microns

15. The coextruded film of claim 2 wherein the first and second faces are outer faces.

16. The coextruded film of claim 3 wherein the first or second face is an inner face covered in whole or part with a third thermoplastic polymer.

17. The coextruded film of claim 16 wherein the third thermoplastic polymer is a continuous film layer.

18. The coextruded film of claim 16 wherein the third thermoplastic polymer is a discontinuous layer.

19. The coextruded film of claim 1 laminated to a nonwoven material
